(19) United States
(12) Patent Application Publication
(10) Pub. No.: US 2015/0095041 A1
(43) Pub. Date: Apr. 2, 2015

(54) SYSTEM FOR CONTROLLING MEDICAL DEVICE BY USING SHORT-RANGE WIRELESS COMMUNICATION TECHNOLOGY AND METHOD OF THE SAME

(71) Applicant: Hongjin Kim, Seoul (KR)

(72) Inventor: Hongjin Kim, Seoul (KR)

(21) Appl. No.: 14/039,170

(22) Filed: Sep. 27, 2013

(51) Int. Cl. G06F 19/00

(52) U.S. Cl. CPC G06F 19/3418
USPC 705/2

(57) ABSTRACT

Disclosed are a system for controlling a medical device by using a short-range wireless communication technology and a method of the same, and more particularly, a system for controlling the medical device by using the short-range wireless communication technology, for example, NFC, Bluetooth and the like. The method is to control the medical equipment by using a smart device and includes: (i) starting an application installed on a smart device 100 (s100); (ii) setting an environmental value to be applied to a medical equipment 200 by using the linked application (s200); (iii) transmitting the set environmental value to the medical equipment 200 (s300); (iv) operating the medical equipment 200 in accordance with the transmitted environmental value (s400); (v) producing health information measured by the operation result of the medical equipment 200 (s500); (vi) transmitting the measured health information to the smart device 100 (s600); and (vii) storing the received measured health information in the smart device 100 (s700).

### BACKGROUND

1. Field

The present invention relates to a system for controlling a medical device by using a short-range wireless communication technology and a method of the same, and more particularly to a system for controlling the medical device by using the short-range wireless communication technology, for example, NFC, Bluetooth and the like.

2. Description of Related Art

Recently, with the rapid development of communication technologies, many telemedicine systems are introduced, which allow a patient to get access to a medical computer attached to a hospital, etc., through Internet and to thereby receiving on-line counseling and treatment.

Home-care technologies are being variously researched and developed. For example, a Patent Application No. 86556 in 2005 has disclosed a technology for remotely monitoring the health status of a patient by means of a biomedical signal sensor which is provided to the patient and detects the health status of the patient, generates and wirelessly transmits a biomedical signal corresponding to the health status, thereby significantly reducing man powers and time required for manually collecting various biomedical signals by doctors or nurses.

Also, with the development of a health care technology combined with a sensor network technology, ubiquitous home health care services have emerged. The ubiquitous home health care service transmits biometric data measured by health care equipment to a health care center. The health care center analyzes the measured biometric data and provides customized health care services.

The ubiquitous home health care service is based on the health care equipment like a blood glucose monitor, a blood pressure monitor and so on, the sensor network technology and a database management technology, etc. That is, the ubiquitous home health care service corresponds to comprehensive health care services that provide statistical information or analysis chart on the basis of personal biometric data of a user, and provide health care contents including customized menu and physical exercise, etc. The ubiquitous home health care service also has a conception that includes a portion of the medical services such as remote video consultation, telemedicine and the like.

Meanwhile, for the purpose of the ubiquitous home health care service, a health care support system that provides the health care service is installed in a service provider, e.g., the health care center, etc. Such a health care support system is commonly implemented as a dedicated system for a single purpose.

To use the home health care service, a variety of medical equipment should be employed in the home. Therefore, there is a requirement for a technology for easily controlling a variety of the medical equipment.

The present invention is designed to apply a short-range wireless communication technology in order to control the medical equipment.

The short-range wireless communication uses an electric wave as a medium for data to be transmitted within a short range area and enables other devices within the short range area to transmit and receive data with each other. A technology which is currently used by such a communication method includes NFC, Radio-Frequency Identification (RFID), Bluetooth, Zigoth, Zig-bee, Wibee, Wi-Fi, direct Fi and the like. These technologies are variously used according to the advantages and disadvantages of the communication methods under the appropriate conditions.

Among these, NFC stands for Near Field Communication and is a kind of the short-range wireless communication method using a frequency band of 13.56 MHz. The NFC has a band of 13.56 MHz and is used for a very short-range wireless communication. Currently, a data communication rate of 424 KB per second is supported and can be employed in a variety of services including transportation, ticket purchase, payment, etc.

The Radio-Frequency Identification (RFID) is a technology for recognizing information from a long distance by using electric waves. This technology requires an RFID tag (hereafter, referred to as tag) and an RFID reader (hereafter, referred to as reader). The tag consists of antennas and integrated circuits. The tag records the information in the integrated circuit and transmits the information to the reader through the antenna. This information is used to identify a tagged object. Easily speaking, this information performs a function similar to that of a barcode. The RFID is different from a barcode system in that the information is read not by light but rather by the electric waves. Unlike a barcode reader, the reader of the RFID is able to read the tag from a long distance as well as a short distance. The reader of the RFID is even able to receive the information via an object located between the tag and the reader.

The RFID may be classified according to the power to use. An RFID that reads the information of a chip and communicates by using only the power of the reader is defined as a passive RFID. An RFID that reads the information of the chip by using the power of a battery built in the tag and communicates by using the power of the reader is defined as a semi-passive RFID. Lastly, an active RFID reads the information of the chip and communicates by using the power of the tag.

The RFID may be classified according to the frequency of the electric wave used in the communication, instead of the power. An RFID that uses a low frequency is referred to as a Low-Frequency Identification (LFID). The LFID uses an electric wave having a frequency of 120 to 140 KHz. A High-Frequency Identification (HFID) uses an electric wave having a frequency of 13.56 MHz. An UltraHigh-Frequency Identification (UHFID) uses an electric wave having a frequency that is much higher than 13.56 MHz, that is, 868 to 956 MHz.

The Zib-bee communication is composed of a PHY layer of IEEE 802.15.4 standard, an application layer based on a MAC layer, and a protocol layer. That is, the IEEE 802.15.4 standard is applied to the hardware of the Zig-bee communication and Zig-bee software are used in the hardware.

The Zig-bee communication uses a frequency of 2.4 GHz in the form of dual PHY and 868/915 MHz (900 MHz band). The Zig-bee communication is composed of a coordinator and an end device. One coordinator is able to communicate with several end devices. Particularly, it has low power consumption and requires low cost.

ISA100/ Wireless HART communication uses PHY based on the IEEE 802.15.4 and uses a protocol capable of solving the disadvantages of the Zig-bee communication. Security problems occurring in the existing Zig-bee communication could be solved through a particular layer that is dedicated to the security. A channel-hopping method has also been applied to the ISA100/ Wireless HART communication in order to overcome the signal collision.

The Bluetooth is the most popular short-range wireless communication technology based on 802.15.1. However, the Bluetooth has disadvantages such as a distance limit (the maximum communication distance is approximately 50 M), a security issue (the most vulnerable only by some cracking technique), etc.

In addition to this, there are also WAVE communication technology used in hi-pass system, NFC that is an ultra short-range communication and the like.

### PRIOR ART DOCUMENT

In Korean Patent Number 10-1121441, disclosed are an NFC type mobile communication terminal and a method for controlling the same. More particularly, with regard to a mobile communication terminal that performs an NFC communication with an NFC type active tag which is convertible to any one of a reader mode and a card mode, and then receives the data stored in the active tag, the mobile communication terminal includes: an NFC antenna which receives NFC type data signals transmitted from the active tag; an NFC controller which controls the active tag and session to be formed in the reader mode and receives the data signal transmitted from the active tag through the NFC antenna; a function controller which is provided with the data signal transmitted from the active tag through the NFC controller, and analyzes the data signal; and a terminal controller which performs at least one selected function of the mobile communication terminal. The data signal of the active tag is a function control signal including an instruction performing the at least one selected function of the mobile communication terminal. The function controller extracts the instructions included in the function control signal and applies the instructions to the terminal controller, so that the instructions included in the function control signal is executed and the selected function of the mobile communication terminal is forcibly controlled. However, the control range of the control method is limited by the internal components of the mobile communication terminal and there is a difference between the above-mentioned control method and the technology for controlling the medical equipment in accordance with the present invention.

### SUMMARY

### Technical Problem

For the purpose of use of home health care service, etc., a variety of medical equipment should be provided to homes. Therefore, there is a requirement for a technology for easily controlling the various medical equipment. The present invention is designed to provide an integrated and simplified control interface for the sake of users, in particular, the old, the disabled and the like who have a difficulty in manipulating the various medical equipment.

### Technical Solution

The present invention provides a method for controlling the medical equipment by using a short-range wireless communication. The method includes:

(i) starting an application installed on a smart device 100 (s100);

(ii) setting an environmental value to be applied to a medical equipment 200 by using the linked application (s200);

(iii) transmitting the set environmental value to the medical equipment 200 (s300);

(iv) operating the medical equipment 200 in accordance with the transmitted environmental value (s400);

(v) producing health information measured by the operation result of the medical equipment 200 (s500);

(vi) transmitting the measured health information to the smart device 100 (s600); and

(vii) storing the received measured health information in the smart device 100 (s700).

Accordingly, the above-mentioned method for controlling the medical equipment by using the short-range wireless communication solves the foregoing problems.

### Advantageous Effect

The present invention provides an integrated and simplified control interface for the sake of users, in particular, the old, the disabled and the like who have a difficulty in manipulating the various medical equipment. Also, the present invention enables small-size medical equipment worn on our body, for example, a portable menstrual pain reliever, a portable kidney dialysis machine, a portable cardiac monitoring device, etc., to make use of the display of a smart device, so that there is no necessity of installing a display device in the medical equipment. Accordingly, it is expected that the medical becomes smaller and the cost is also reduced.

### BRIEF DESCRIPTION OF THE DRAWINGS

FIG. 1 is a view showing a configuration of a medical equipment control system using a short-range wireless communication in accordance with the present invention;

FIG. 2 is a flowchart showing a method for controlling the medical equipment by using the short-range wireless communication in accordance with the present invention;

FIG. 3 is a block diagram for describing a smart device of the medical equipment control system using the short-range wireless communication in accordance with the present invention; and

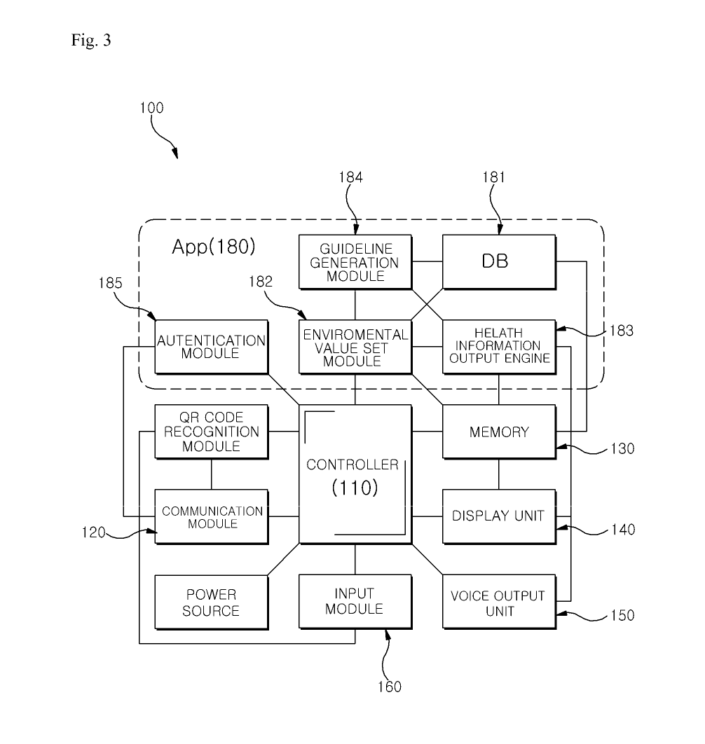

FIG. 4 is a view showing a configuration of a health information management system using the method for controlling the medical equipment through use of the short-range wireless communication in accordance with the present invention.

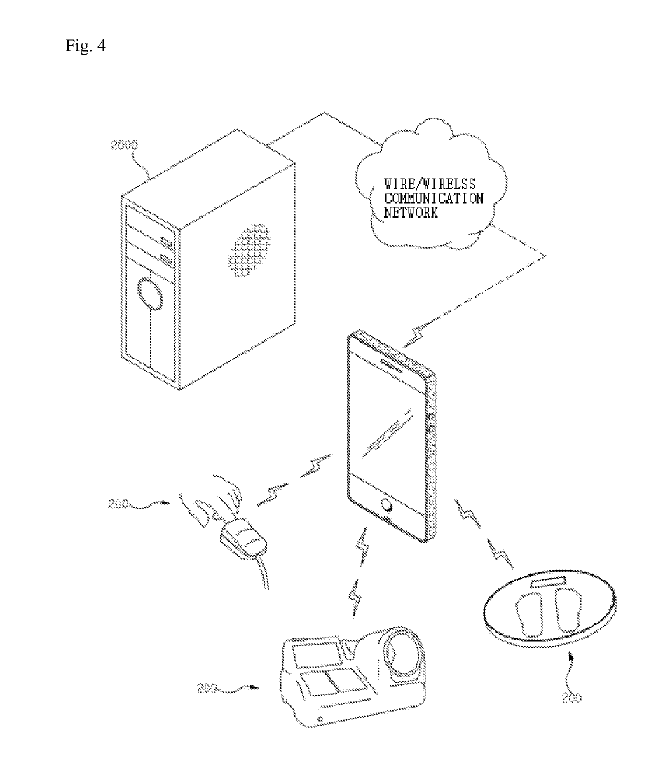

### DETAILED DESCRIPTION

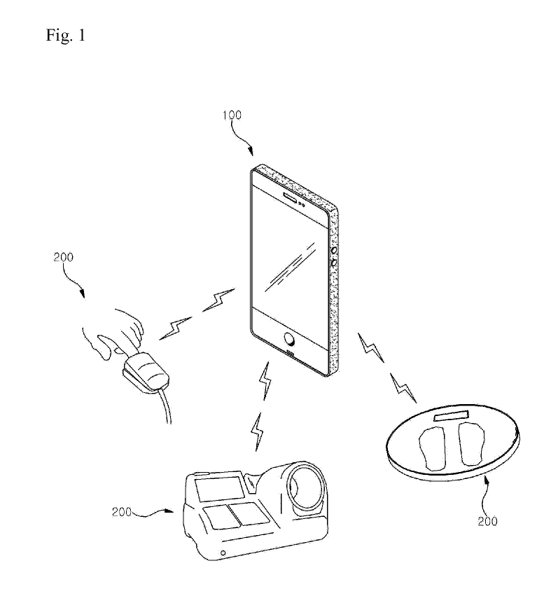

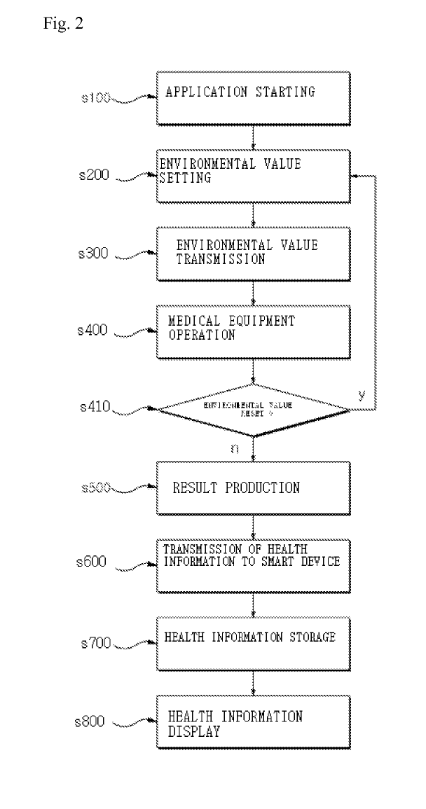

The present invention relates to a system for controlling a medical device by using a short-range wireless communication technology and a method of the same, and more particularly to a system for controlling the medical device by using the short-range wireless communication technology, for example, NFC, Bluetooth and the like. Hereafter, a detailed description thereof will be provided with reference to the accompanying drawings. FIG. 1 is a view showing a configuration of a medical equipment control system using a short-range wireless communication in accordance with the present invention. FIG. 2 is a flowchart showing a method for controlling the medical equipment by using the short-range wireless communication in accordance with the present invention.

The present invention relates to a method for controlling the medical equipment by using a smart device and a short-range wireless communication. The method includes:

(i) starting an application installed on a smart device 100 (s100);

(ii) setting an environmental value to be applied to a medical equipment 200 by using the linked application (s200);

(iii) transmitting the set environmental value to the medical equipment 200 (s300);

(iv) operating the medical equipment 200 in accordance with the transmitted environmental value (s400);

(v) producing health information measured by the operation result of the medical equipment 200 (s500);

(vi) transmitting the measured health information to the smart device 100 (s600); and

(vii) storing the received measured health information in the smart device 100 (s700).

The smart device 100 may include a smart phone, a smart tablet, a smart player, etc. In addition, a general-purpose or dedicated portable personal terminal, a laptop and a wearable smart device such as a smart watch, a smart glass, etc., may be used as the smart device 100.

The environmental value corresponds to a parameter set value for the purpose of operating the medical equipment 200, for example, the operation time, operation intensity, level of measurement, etc. The short-range wireless communication is used in the step (s300) of transmitting the set environmental value to the medical equipment 200 and the step (s600) of transmitting the measured health information to the smart device 100.

It is preferable that the short-range wireless communication uses the Near Field Communication (NFC) using a frequency band of 13.56 MHz.

Also, the short-range wireless communication may employ the Bluetooth using a frequency band of 2.4 to 2.5 GHz.

As another embodiment, the short-range wireless communication may employ Zig-bee using a frequency band of 2.4 GHz and 868/915 MHz (900 MHz band), or may employ at least any one selected from the group consisting of Wi-Fi, Infrared Data Association (IrDA), WLAN, High Rate WPAN, UWB, Wireless 1394 and QR code.

In the step (s300) of transmitting the set environmental value to the medical equipment 200 and the step (s600) of transmitting the measured health information to the smart device 100, it is preferable to apply a method of transmitting the set environmental value or the measured health information by causing the smart device 100 to be close to a communication module (not shown) of the medical equipment 200 through the use of a reader-writer mode where either the smart device 100 or the medical equipment 200 becomes a Writer mode.

As further another embodiment, in the step (s300) of transmitting the set environmental value to the medical equipment 200 and the step (s600) of transmitting the measured health information to the smart device 100, it may be possible to apply a method of transmitting the environmental value set in the smart device 100 or the measured health information by causing the smart device 100 to be close to the communication module of the medical equipment 200 through the use of a card emulation mode.

As yet further another embodiment, in the step (s300) of transmitting the set environmental value to the medical equipment 200 and the step (s600) of transmitting the measured health information to the smart device 100, it may be possible to apply a Peer-to-peer (P2P) method between the short-range wireless communication modules of the smart device 100 and the medical equipment 200.

The step (s400) of operating the medical equipment in accordance with the transmitted environmental value may include a step (s410) of determining whether or not the environmental value is reset. When the environmental value is reset in the step (s410), the medical equipment reflects the reset environmental value and re-operates.

It is preferable to add a step (s800) of displaying the measured health information after the step (s700) of storing the received measured health information in the smart device 100. The health information is directly output on the smart device 100, so that the use history does not remain in the medical equipment. Accordingly, it is possible to expect high security effect.

Also, the step (s400) of operating the medical equipment in accordance with the transmitted environmental value may include an operation information display step (s420) in which the smart device 100 receives and displays the operation information of the medical equipment. According to this method, there is no necessity of installing a display device in the medical equipment. Accordingly, it is expected that the medical becomes smaller and the cost is also reduced. For example, this method enables small-size medical equipment worn on our body, for example, a portable menstrual pain reliever, a portable kidney dialysis machine, a portable cardiac monitoring device, etc., to make use of the display of the smart device.

The step (s800) of displaying the measured health information may include a guideline display step (s810) of displaying a guideline generated from a guideline generation module 184 of the smart device 100. It is preferable that the guideline includes a simple condition assessment, e.g., determination of high or low blood pressure and the like.

Moreover, the present invention provides a method for managing the health information. The method for managing the health information includes:

the method for controlling the medical equipment by using the short-range wireless communication;

requesting a health information management server 300 the environmental value (s110);

receiving the environmental value from the health information management server 300 (s120);

transmitting the health information measured and collected by the method for controlling the medical equipment, to the health information management server 300 (s1000); and

receiving a guideline based on the transmitted health information from the health information management server 300 (s2000).

In the step (s110) of requesting the health information management server 300 the environmental value and the step (s120) of receiving the environmental value from the health information management server 300, for the sake of users who have a difficulty in setting the environmental value for the control of the medical equipment 200, it is possible to easily set the environmental value by requesting the health information management server 300 the environmental value and receiving the environmental value. Particularly, when a lot of the medical equipment 200 should be used, such the method of receiving the environmental value from the health information management server 300 helps old patients who are not skilled in devices to operate many medical equipment 200 with ease.

Also, the health information can be managed through the step (s1000) of transmitting the health information and the step (s2000) of receiving the guideline.

The present invention provides the smart device for controlling the medical equipment by using the short-range wireless communication. The smart device includes a controller 110 for controlling the smart device, a communication module 120 for communicating with the medical equipment 200, a memory 130 for storing the health information data received from a kiosk 200, a display unit 140 for displaying the information including the health information, a voice output unit 150 for outputting the information including the health information in the form of voice, an input module 160 for allowing users to input, a QR code recognition module 170 (e.g., a camera) for recognizing QR codes, and an application 180 which is a software for managing the health information, and power source for device.

It is preferable that the application 180 includes an environmental value set module 181 for setting the environmental value, a database (DB) 182 for storing the health information, and a health information output engine 183 for outputting the image/sound of the health information. The application 180 may further include the guideline generation module 184 for generating the described guideline, and an authentication module 185 for authenticating by the health information management server 300.

That is, the present invention provides the short-range wireless communication medical equipment control system and the health information management system. The short-range wireless communication medical equipment control system is comprised of both the smart device 100 for controlling the medical equipment by using the short-range wireless communication and the medical equipment 200 including the communication module for communicating with the smart device 100. The health information management system includes the health information management server 300 for managing the measured health information, and uses the method for controlling the medical equipment through use of the short-range wireless communication. According to the above-mentioned configuration, it is possible to provide an integrated and simplified control interface for the sake of users, in particular, the old, the disabled and the like who have a difficulty in manipulating the various medical equipment, and possible to easily manage the health information.

The present invention has been described with reference to the accompanying drawings. This is just one of various embodiments including the subject matter of the present invention and intends to allow those skilled in the art to easily embody the present invention. It is clear that the present invention is not limited to the above-described embodiments. Therefore, the scope of the present invention should be construed by the following claims. Without departing from the subject matter of the present invention, all the technical spirits within the scope equivalent to the subject matter of the present invention is included in the right scope of the present invention by the modifications, substitutions, changes and the like. Also, it is clear that some of the drawing configuration are intended for more clearly describing the configuration and are more exaggerated or shortened than the actual one.

What is claimed is:

1. A method for controlling a medical equipment by using a short-range wireless communication, the method comprising:
(i) starting an application installed on a smart device 100 (s100);
(ii) setting an environmental value to be applied to a medical equipment 200 by using the linked application (s200);
(iii) transmitting the set environmental value to the medical equipment 200 (s300);
(iv) operating the medical equipment 200 in accordance with the transmitted environmental value (s400);
(v) producing health information measured by the operation result of the medical equipment 200 (s500);
(vi) transmitting the measured health information to the smart device 100 (s600); and
(vii) storing the received measured health information in the smart device 100 (s700).

2. The method of claim 1, wherein the smart device 100 is any one selected from the group consisting of a smart phone, a smart tablet, a smart watch, a smart glass, a portable personal terminal, a laptop and a smart player.

3. The method of claim 1, wherein the short-range wireless communication is used in the step (s300) of transmitting the set environmental value to the medical equipment 200 and the step (s600) of transmitting the measured health information to the smart device 100.

4. The method of claim 3, wherein the short-range wireless communication uses Near Field Communication (NFC) using a frequency band of 13.56 MHz.

5. The method of claim 3, wherein the short-range wireless communication uses Bluetooth using a frequency band of 2.4 to 2.5 GHz.

6. The method of claim 3, wherein the short-range wireless communication uses Zig-bee using a frequency band of 2.4 GHz and 868/915 MHz (900 MHz band).

7. The method of claim 3, wherein the short-range wireless communication uses at least any one selected from the group consisting of Infrared Data Association (IrDA), WLAN, High Rate WPAN, UWB, Wireless 1394 and QR code.

8. The method of claim 3, wherein, in the step (s300) of transmitting the set environmental value to the medical equipment 200 and the step (s600) of transmitting the measured health information to the smart device 100, the set environmental value or the measured health information is transmitted by causing the smart device 100 to be close to a communication module of the medical equipment 200 through the use of a reader-writer mode where either the smart device 100 or the medical equipment 200 becomes a Writer mode.

9. The method of claim 3, wherein, in the step (s300) of transmitting the set environmental value to the medical equipment 200 and the step (s600) of transmitting the measured health information to the smart device 100, the environmental value set in the smart device 100 or the measured health information is transmitted by causing the smart device 100 to be close to the communication module of the medical equipment 200 through the use of a card emulation mode.

10. The method of claim 3, wherein, in the step (s300) of transmitting the set environmental value to the medical equipment 200 and the step (s600) of transmitting the measured health information to the smart device 100, a Peer-to-peer (P2P) method is used between the short-range wireless communication modules of the smart device 100 and the medical equipment 200.

11. The method of claim 1, wherein the step (s400) of operating the medical equipment in accordance with the transmitted environmental value comprises a step (s410) of determining whether or not the environmental value is reset.

12. The method of claim 1, wherein the step (s400) of operating the medical equipment in accordance with the transmitted environmental value comprises an operation information display step (s420) in which the smart device 100 receives and displays the operation information of the medical equipment.

13. The method of claim 1, wherein a step (s800) of displaying the measured health information is added after the step (s700) of storing the received measured health information in the smart device 100.

14. The method of claim 12, wherein the step (s800) of displaying the measured health information comprises a guideline display step (s810) of displaying a guideline generated from a guideline generation module 184 of the smart device 100.

15. The method of any one claim of claims 1 to 14 for controlling a medical equipment by using a short-range wireless communication, the method comprising:
requesting a health information management server 300 the environmental value (s110);
receiving the environmental value from the health information management server 300 (s120);
transmitting the health information measured and collected by the method for controlling the medical equipment, to the health information management server 300 (s1000); and
receiving a guideline based on the transmitted health information from the health information management server 300 (s2000).

16. A smart device for controlling a medical equipment by using a short-range wireless communication, the smart device comprising: a controller 110 for controlling the smart device, a communication module 120 for communicating with the medical equipment 200, a memory 130 for storing the data received from the medical equipment 200, a display unit 140 for displaying the information, a voice output unit 150 for outputting the information in the form of voice, an input module 160 for allowing users to input, and an application 180 which is a software for managing the health information, wherein the application 180 comprises an environmental value set module 181 for setting the environmental value of the medical equipment 200, a database (DB) 182 for storing the health information, and a health information output engine 183 for outputting the image/sound of the health information.

17. The smart device of claim 16, wherein the communication module 120 comprises a Bluetooth module, a Zig-bee module, an Infrared Data Association (IrDA) module, a WLAN module, and a module for generating and receiving a high rate WPAN, UWB, Wireless 1394 and QR code.

18. A medical equipment control system which uses a short-range wireless communication and measures health information, the system comprising:
the smart device 100 of either claim 16 or 17 for controlling the medical equipment by using the short-range wireless communication; and
the medical equipment 200 including the communication module for communicating with the smart device 100.

19. A health information management system using a method for controlling a medical equipment through use of a short-range wireless communication, the system comprising:
the smart device 100 of either claim 16 or 17 for controlling the medical equipment by using the short-range wireless communication;
the medical equipment 200 including the communication module for communicating with the smart device 100; and
a health information management server 300 for managing measured health information.
